(19) United States
(12) Patent Application Publication
(10) Pub. No.: US 2003/0005162 A1
(43) Pub. Date: Jan. 2, 2003

(54) Network comprising a plurality of sub-networks for determining bridge terminals

(76) Inventor: Joerg Habetha, Aachen (DE)

Correspondence Address: US Philips Corporation, Intellectual Property Department, 580 White Plains Road, Tarrytown, NY, 10591, US

(21) Appl. No.: 10/169,348

(22) PCT Filed: Oct. 24, 2001
(86) PCT No.: PCT/EP01/12426

(30) Foreign Application Priority Data
Oct. 30, 2000 (DE) 100 53 854.1

(51) Int. Cl. G06F 15/16

(52) U.S. Cl. 709/249

(57) ABSTRACT

The invention relates to a network comprising a plurality of sub-networks, which sub-networks can each be connected via bridge terminals and comprise each a controller for controlling one sub-network. A controller is provided for setting up a connection between two sub-networks via a possible bridge terminal. The order of the connection set-up is determined first by the minimum number of possible bridge terminals between two sub-networks and then by the connection quality.

The invention relates to a network comprising a plurality of sub-networks, which sub-networks can each be connected via bridge terminals and comprise each a controller for controlling one sub-network. Such networks are self-organizing and may comprise, for example, a plurality of sub-networks. They are also referred to as ad hoc networks.

The document “J. Habetha, A. Hettich, J. Peetz, Y. Du: Central Controller Handover Procedure for ETSI-BRAN HIPERLAN/2 Ad Hoc Networks and Clustering with Quality of Service Guarantees, 1^{st} IEEE Annual Workshop on Mobile Ad Hoc Networking & Computing, Aug. 11, 2000”, discusses an ad hoc network comprising a plurality of terminals. At least one terminal is provided as a controller for controlling the ad hoc network. Under certain conditions it may be necessary for another terminal to become controller. If such a network reaches a certain size, it is necessary to subdivide it into sub-networks. Terminals arranged as bridge terminals are used for the communication with the subnetworks.

It is an object of the invention to provide a network which enables determining bridge terminals in a simple manner.

The object is achieved by a network of the type defined in the opening paragraph by the following measures: A network comprising sub-networks which can each be connected via bridge terminals and which comprise each a controller for controlling one sub-network, which controller is provided for setting up a connection between two sub-networks via a possible bridge terminal, in which the order of the connection set-up is first determined by the minimum number of possible bridge terminals between two sub-networks and then by the connection quality.

The data which are transmitted in the network may be generated, for example, in accordance with a packet transmission method. The packets may be transmitted over the wireless medium as whole packets or as sub-packets after further information has been affixed. A wireless transmission is understood to mean a radio, infrared or ultrashell transmission etc. As a packet transmission method may be used, for example, the asynchronous transfer mode (ATM), which generates packets of fixed length which are called cells.

These and other aspects of the invention are apparent from and will be elucidated with reference to the embodiments described hereinafter.

In the drawings:

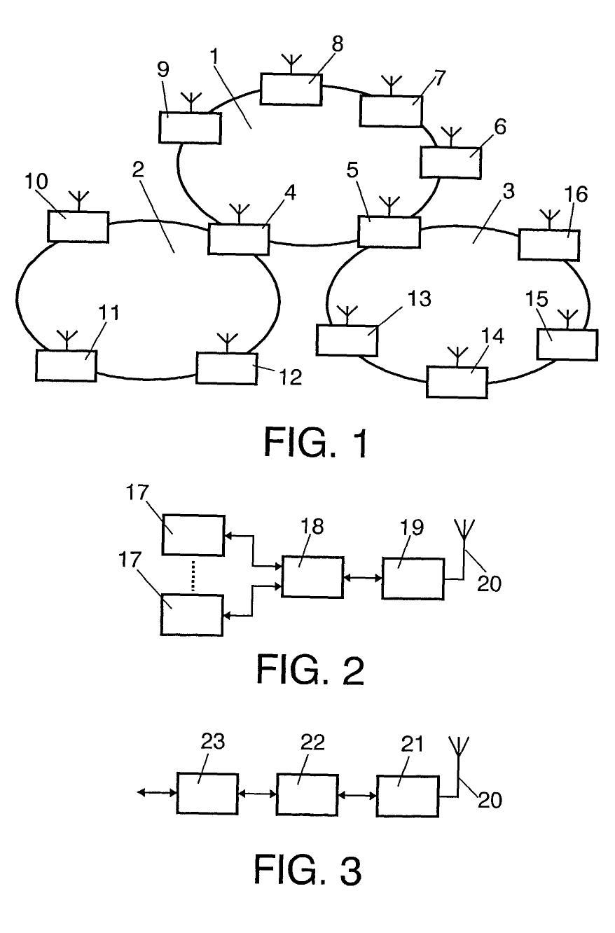

FIG. 1 shows an ad hoc network comprising three sub-networks which each contain terminals provided for radio transmission,

FIG. 2 shows a terminal of the local area network as shown in FIG. 1,

FIG. 3 shows a radio device of the terminal shown in FIG. 2,

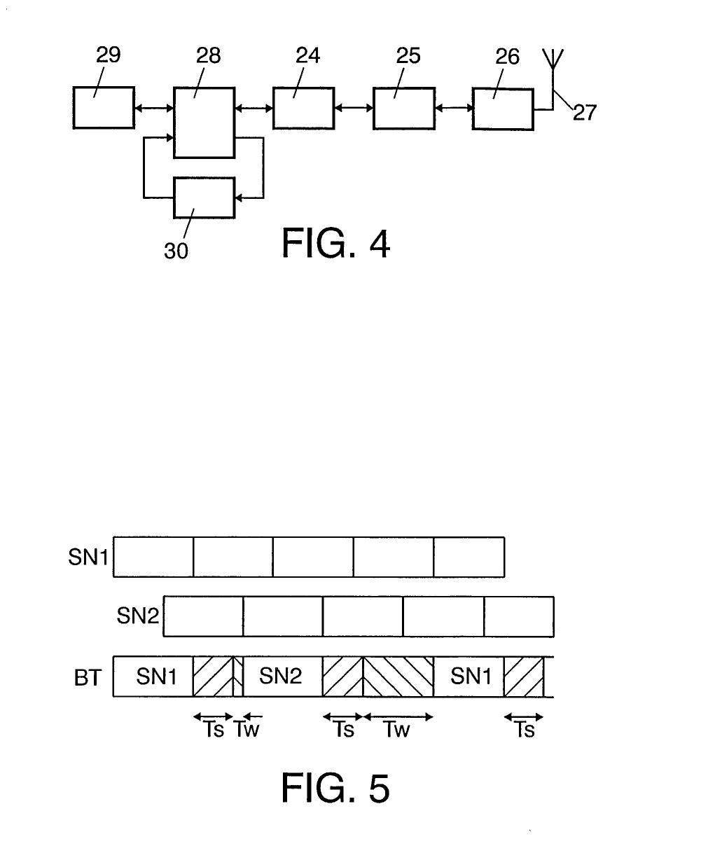

FIG. 4 shows an embodiment of a bridge terminal provided as a connection between two sub-networks,

FIG. 5 shows MAC frames of two sub-networks and the MAC frame structure of a bridge terminal,

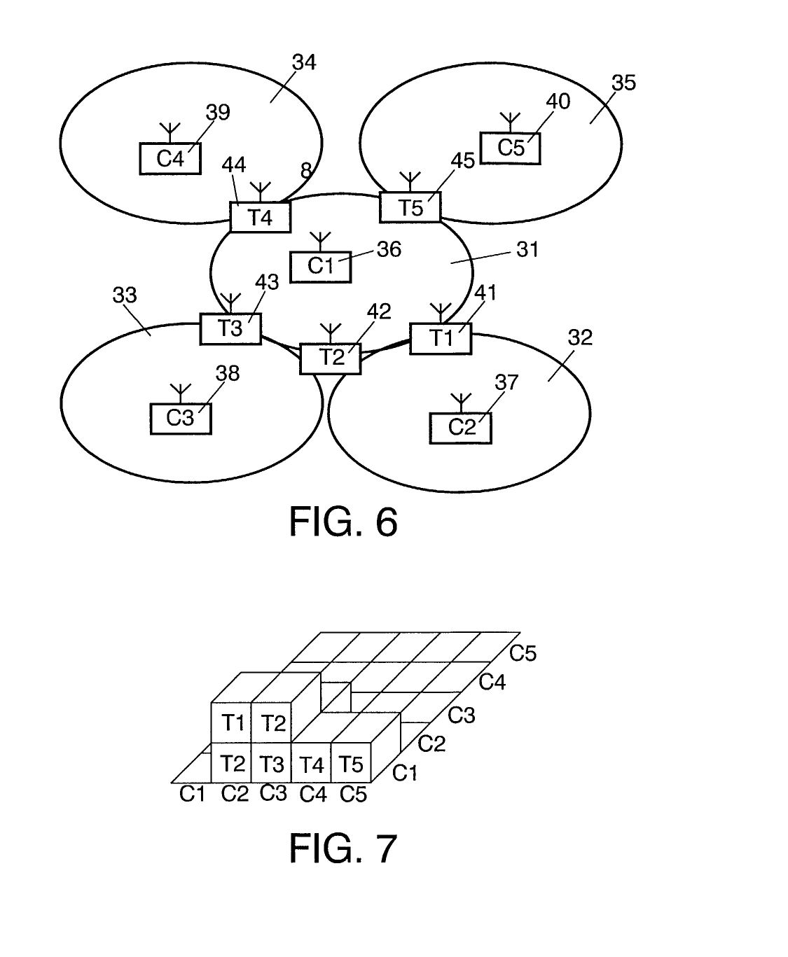

FIG. 6 shows an example of an ad hoc network comprising five sub-networks, and

FIG. 7 shows a symbolically represented matrix which is stored in a controller for finding a bridge terminal.

The example of embodiment shown in the following relates to ad hoc networks which are self-organizing, which is in contrast to traditional networks. Each terminal in such an ad hoc network may make access possible to a fixed network and can immediately be used. An ad hoc network is characterized in that the structure and the number of subscribers are not fixed within predefined limit values. For example, a subscriber's communication device may be removed from the network or included therein. Contrary to traditional mobile radio networks, an ad hoc network is not limited to a fixedly installed infrastructure.

The size of the area of the ad hoc network is usually much larger than the transmission range of one terminal. A communication between two terminals may therefore require that further terminals be switched on, so that these messages or data can be transmitted between the two communicating terminals. Such ad hoc networks, in which a transfer of messages and data over a terminal is necessary, are referred to as multihop ad hoc networks. A possible organization of an ad hoc network consists of regularly forming sub-networks or clusters. A sub-network of the ad hoc network can be formed, for example, by terminals connected via radio paths of subscribers sitting at a table. Such terminals may be, for example, communication devices for the wireless exchange of messages, pictures and so on.

There may be two types of ad hoc networks. They are decentralized and centralized ad hoc networks. In a decentralized ad hoc network the communication between the terminals is decentralized, that is to say, each terminal can directly communicate with any other terminal, provided that the terminals are located within the transmission range of the other terminal. The advantage of a decentralized ad hoc network is its simplicity and robustness to errors. In a centralized ad hoc network, certain functions such as, for example, the function of multiple access of a terminal to the radio transmission medium (Medium Access Control=MAC) is controlled by one specific terminal per sub-network. This terminal is referred to as central terminal or central controller (CC). These functions need not always be carried out by the same terminal, but can be handed over by a terminal acting as a central controller to another terminal then acting as a central controller. The advantage of a centralized ad hoc network is that in this network an agreement about the quality of service (QoS) is possible in a simple manner. An example for a centralized ad hoc network is a network that is organized according to the HiperLAN/2 Home Environment Extension (HEE) (compare J. Habetha, A. Hettich, J. Peetz, Y. Du, “Central Controller Handover Procedure for ETSI-BRAN HIPERLAN/2 Ad Hoc Networks and Clustering with Quality of Service Guarantees”, 1^{st} IEEE Annual Workshop on Mobile Ad Hoc Networking & Computing, Aug. 11, 2000).

FIG. 1 shows an example of embodiment of an ad hoc network having three sub-networks 1 to 3, which each contain a plurality of terminals 4 to 16. Constituent parts of the sub-network 1 are the terminals 4 to 9, of the sub-network 2 the terminals 4 and 10 to 12, and of the sub-network 3 the terminals 5 and 13 to 16. In a sub-network the terminals belonging to a respective sub-network exchange data over radio paths. The ellipses shown in FIG. 1 indicate the radio coverage of a sub-network (1 to 3), in which a largely problem-free radio transmission is possible between the terminals belonging to the sub-network.

The terminals 4 and 5 are called bridge terminals, because they enable an exchange of data between two sub-networks 1 and 2 or 1 and 3, respectively. The bridge terminal 4 is used for the data traffic between the sub-networks 1 and 2 and the bridge terminal 5 for the data traffic between the sub-networks 1 and 3.

A terminal 4 to 16 of the local area network shown in FIG. 1 may be a mobile or fixed communication device and comprises, for example, at least a station 17, a connection controller 18 and a radio device 19 with an antenna 20, as shown in FIG. 2. A station 17 may be, for example, a portable computer, telephone and so on and so forth.

A radio device 19 of the terminals 6 to 16 comprises, as shown in FIG. 3, in addition to the antenna, a high-frequency circuit 21, a modem 22 and a protocol device 23. The protocol device 23 forms packet units from the data stream received from the connection controller 18. A packet unit contains parts of the data stream and additional control information formed by the protocol device 23. The protocol device uses protocols for the LLC layer (LLC=Logic Link Control) and the MAC layer (MAC=Medium Access Control). The MAC layer controls the multiple access of a terminal to the radio transmission medium and the LLC layer carries out a flow and error control.

As observed above, in a sub-network 1 to 3 of a centralized ad hoc network, a specific terminal is responsible for the control and management functions and is referred to as central controller. The controller furthermore works as a normal terminal in the associated sub-network. The controller is responsible, for example, for the registration of terminals that operate in the sub-network, for the connection set-up between at least two terminals in the radio transmission medium, for the resource management and for the access control in the radio transmission medium. For example, after the registration and announcement of a transmission request a terminal of a sub-network is assigned transmission capacity for data (packet units) by the controller.

In the ad hoc network, the data can be exchanged between the terminals in accordance with a TDMA, FDMA or CDMA method (TDMA=Time Division Multiple Access, FDMA=Frequency Division Multiple Access, CDMA=Code Division Multiple Access). The methods may also be combined. To each sub-network 1 to 3 of the local area network are assigned a number of specified channels which are referred to as a channel group. A channel is determined by a frequency range, a time range and, for example in CDMA methods, by a spreading code. For example, each sub-network 1 to 3 can have a certain, respectively different frequency range available for the data exchange, which range has a carrier frequency fᵢ. In such a frequency range may be transmitted, for example, data by means of the TDMA method. The sub-network 1 may then be assigned the carrier frequency f₁, the sub-network 2 the carrier frequency f₂ and the sub-network 3 the carrier frequency f₃. The bridge terminal 4 works at the carrier frequency f₁, on the one hand, to carry out an exchange of data with the other terminals of the sub-network 1 and, on the other hand, at the carrier frequency f₂, to carry out a data exchange with the other terminals of the sub-network 2. The second bridge terminal 5 contained in the local area network, which bridge terminal 5 transmits data between the sub-networks 1 and 3, works at the carrier frequencies f₁, and f₃.

As observed above, the central controller has, for example, the function of access controller. This means that the central controller is responsible for the formation of frames of the MAC layer (MAC frames). For this purpose the TDMA method is used. Such a MAC frame has various channels for control information and useful data.

A block diagram of an example of embodiment of a bridge terminal is shown in FIG. 4. The radio switching device of this bridge terminal comprises a protocol device 24, a modem 25 and a high-frequency circuit 26 with an antenna 27. To the protocol device 24 is connected a radio switching device 28, which is further connected to a connection controller 29 and a buffer arrangement 30. In this embodiment the buffer arrangement 30 contains one storage element and is used for buffering data and realized as a FIFO module (First In First Out), that is, the data are read from the buffer arrangement 30 in the order in which they were written. The terminal shown in FIG. 4 may also work as a normal terminal. Stations not shown in FIG. 4, but connected to the connection controller 29, then supply data to the radio switching device 28 via the connection controller 29.

The bridge terminal shown in FIG. 4 is alternately synchronized with a first and a second sub-network. Synchronization is understood to mean the entire process of integrating a terminal with the sub-network for the exchange of data. If the bridge terminal is synchronized with the first sub-network, it can exchange data with all the terminals and with the controller of this first sub-network. If the connection controller 29 supplies data to the radio switch device 28, the destination of which data is a terminal or the controller of the first sub-network, or a terminal or controller of another sub-network that can be reached via the first sub-network, the radio switch device conveys these data directly to the protocol device 24. In the protocol device 24 the data are buffered until the time slot is reached which the controller has intended to be used for the transmission. If the data coming from the connection controller 29 are to be transmitted to a terminal or to the controller of the second sub-network, or to another sub-network to be reached via the second sub-network, the radio transmission is to be delayed until the time slot in which the bridge terminal is synchronized with the second sub-network. For this purpose, the radio switch device transports the data whose destination lies in the second sub-network, or whose destination can be reached via the second sub-network, to the buffer device 30, which buffers the data until the bridge terminal is synchronized with the second sub-network.

If data from a terminal or the controller of the first sub-network are received by the bridge terminal and their destination is a terminal or the controller of a second subnetwork, or a terminal or controller of another sub-network to be reached via the second subnetwork, these data are stored in the buffer device 30 until the synchronization with the second sub-network. Data whose destination is a station of the bridge terminal are directly conveyed to the connection controller 29 via the radio switch device 28, which controller then leads the received data to the desired station. Data whose destination is neither a station of the bridge terminal nor a terminal or controller of the second sub-network, are sent, for example, to a further bridge terminal.

After the change of synchronization of the bridge terminal from the first to the second sub-network, the data located in the buffer device 30 are read out again from the buffer device 30 in the order in which they have been written. Subsequently, during the time when the bridge terminal is synchronized with the second sub-network, all the data whose destination is a terminal or the controller of the second sub-network, or another sub-network to be reached via the second sub-network, are immediately conveyed to the protocol device 24 by the radio switch device 28, and only the data whose destination is a terminal or the controller of the first sub-network, or another sub-network to be reached via the first subnetwork, are stored in the buffer device 30.

The MAC frames of two sub-networks SN1 and SN2 are usually not synchronized. Therefore, a bridge terminal BT is not only connected to a sub-network SN1 or SN2 during a change-over time Ts, but also during a waiting time Tw. This can be learnt from FIG. 5, which shows a sequence of MAC frames of the sub-networks SN1 and SN2 and the MAC frame structure of the bridge terminal BT. The change-over time Ts is the time that is necessary for the bridge terminal to be able to synchronize with the sub-network. The waiting time Tw indicates the time between the end of the synchronization with the subnetwork and the beginning of a new MAC frame of this sub-network.

Assuming that the bridge terminal BT is connected to a sub-network SN1 or SN2 only for the duration of a MAC frame, the bridge terminal BT has only a channel capacity of ¼ of the available channel capacity of a sub-network. In the other extreme case, where the bridge terminal BT is connected to a sub-network for a longer period of time, the channel capacity is half the available channel capacity of a sub-network.

As described above, each sub-network includes a central controller for controlling the assigned sub-network. When a sub-network is taken into operation, it is to be ensured that only one terminal takes over the function of central controller. It is assumed that not any terminal can take over the function of central controller. When a central controller is determined, the procedure is, for example, that each terminal that can take over a function of controller checks whether in its receive range there is another terminal that can carry out the function of controller. If this is the case, the detecting terminal establishes that it does not become the controller. If all the other terminals also make this check, in the end there will be one terminal that detects no other terminal that has the function of controller and it thus takes over the function of controller.

After the respective sub-networks have been formed, bridge terminals are to be determined which enable a communication between the respective sub-networks. For this purpose, all the terminals located within a certain distance from the assigned controller scan at regular distances the whole permitted frequency range to find out whether they are located within radio range of another controller. When this is the case, the terminal is to announce this to the controllers found. They can then use the terminal as a bridge terminal. If, for example, two sub-networks can be connected by a plurality of bridge terminals, the bridge terminal offering the best constellation is found with a procedure described below.

An example of this is shown in FIG. 6, which shows an ad hoc network with five sub-networks 31 to 35 and five assigned controllers 36 to 40 (C1 to C5). The controllers 36 (C1) and 37(C2) may be connected via bridge terminals 41 and 42 (T1 and T2), the controllers 36 (C1) and 38 (C3) via the bridge terminals 42 and 43 (T2 and T3), the controllers 36 (C1) and 39 (C4) via the bridge terminal 44 (T4), the controllers 36 (C1) and 40 (C5) via the bridge terminal 45 (T5) and the controllers 37 (C2) and 38 (C3) via the bridge terminal 42 (T2). FIG. 6 thus shows two bridge terminals 42 (T2) and 43 (T3), which are both possible candidates for being used as the bridge terminal for connecting the sub-networks 31 and 33. For the connection of the sub-networks 32 and 38 can only be used the bridge terminal 42 (T2).

For providing an efficient connection of two sub-networks, at least one bridge terminal is to be used for connecting the two sub-networks. If the bridge terminal 42 (T2) is chosen for the connection of the sub-networks 31 and 33, no bridge terminal is left for the connection of the sub-networks 32 and 33. Such a situation must be avoided.

In the following a process is presented which permits an optimal choice of bridge terminals for the connection between various sub-networks. First all the bridge terminals between two sub-networks are to set up a connection while the lowest number of bridge terminals is a candidate for such a connection.

The process is carried out by each controller. The known data are then locally stored by each controller. The controller carrying out the process is called processing controller then. All the terminals that can be used as bridge terminals in the available network constellation are described by a three-dimensional matrix F(1 . . . n; 1 . . . n; 1 . . . t), where n is the number of controllers known to the processing controller and t the number of possible bridge terminals. If m bridge terminals are available, which can set up a connection between two sub-networks with the identifications i and j (i<j), their identifications are sorted at the matrix positions F(i, j, 1 . . . m). Such an identification uniquely identifies each terminal. The matrix is then resorted. The sorting criterion is the connection quality of each bridge terminal. The bridge terminal having the best connection quality is sorted at the matrix position F(i, j, 1). Such a symbolically shown matrix structure is shown in FIG. 7.

The following procedure is repeated until the matrix is empty:

a) With each step the processing controller searches for the matrix position for the connection between two sub-networks i and j (i<j) having the smallest m. m indicates the number of possible bridge terminals.

b) The terminal having the identification tk, which is registered at the matrix position F(i, j, 1), is selected to be the bridge terminal for the sub-networks i and j.

c) All entries for this matrix position F(i, j, 1) are erased.

d) The identification tk is searched for in the whole matrix and erased.

With the aid of this operation the bridge terminals having the best properties are determined and thus an optimal structure is found relating to the bridge terminals.

1. A network comprising a plurality of sub-networks, which sub-networks can each be connected via bridge terminals and comprise each a controller for controlling one sub-network, which controller is provided for setting up a connection between two subnet-works via a possible bridge terminal, the order in which the connection is set up first being dependent on the minimum number of possible bridge terminals between two sub-networks and then on the connection quality.

2. A network as claimed in claim 1, characterized in that a controller is arranged for
storing all possible bridge terminals in a matrix F(1 . . . n, 1 . . . n, 1 . . . t), where n is the a number of respective known controllers and t the number of possible bridge terminals,
sorting the matrix elements in dependence on the connection quality,
a repeated search for possible bridge terminals having the smallest number t as a bridge terminal and, after the selection, erasing the matrix element.
